(19) United States
(12) Patent Application Publication
(10) Pub. No.: US 2017/0247604 A1
(43) Pub. Date: Aug. 31, 2017

(54) PROCESS FOR OIL RECOVERY

(71) Applicant: SHELL OIL COMPANY, Houston, TX (US)

(72) Inventor: Jeffrey George SOUTHWICK, Rijswijk (NL)

(21) Appl. No.: 15/440,894

(22) Filed: Feb. 23, 2017

Related U.S. Application Data
(60) Provisional application No. 62/299,927, filed on Feb. 25, 2016.

(51) Int. Cl. C09K 8/588; E21B 43/16; C01B 3/48; C09K 8/584; C09K 8/594

(52) U.S. Cl. CPC C09K 8/588; C09K 8/584; C09K 8/594; C01B 3/48; E21B 43/16; C01C 1/026

(57) ABSTRACT

A process for recovering oil and gas from an underground formation by injecting an ammonia containing enhanced oil recovery formulation into the oil-bearing formation, which process comprises (i) reacting steam with methane containing gas, (ii) combining the reaction mixture obtained with further steam, (iii) removing carbon dioxide to obtain hydrogen, (iv) reacting at least part of the hydrogen with nitrogen, (v) separating off ammonia, (vi) mixing ammonia with water and injecting it into the underground formation, (vii) recovering oil and gas, (viii) separating methane from the fluid recovered from the recovery well, (ix) removing sulfur compounds, and (ix) using in step (i) the methane obtained in step (viii).

This application claims the benefit of U.S. Provisional Application No. 62/299,927 filed Feb. 25, 2016, which is incorporated herein by reference.

### FIELD OF THE INVENTION

The present disclosure relates to a process for recovering oil and gas from an underground formation by injecting an ammonia containing enhanced oil recovery formulation into the oil-bearing formation.

### BACKGROUND OF THE INVENTION

In natural mineral oil deposits, mineral oil is present in the cavities of porous formation rocks which tend to be sealed toward the surface of the earth by impermeable top layers. The cavities may be very fine cavities, capillaries, pores or the like.

In mineral oil production, a distinction is drawn between primary and subsequent production such as secondary and/or tertiary production.

In primary production, after commencement of drilling of the deposit, the mineral oil flows of its own accord through the borehole to the surface owing to the autogeneous pressure of the deposit. The autogeneous pressure can be caused, for example, by gases present in the deposit, such as methane, ethane or propane. The autogeneous pressure of the deposit, however, generally declines relatively rapidly on extraction of mineral oil, such that usually only a limited amount of the mineral oil present in the deposit can be produced in this way. Primary production is no longer feasible if natural reservoir drive diminishes. In these instances, secondary recovery methods can be applied. Secondary methods typically rely on the supply of external energy into the reservoir in the form of injecting fluids to increase reservoir pressure, hence replacing or increasing the natural reservoir drive with an artificial drive. Reservoir pressure may be increased through the injection of water and/or natural gas. The injected fluid is typically immiscible, or predominantly immiscible with the in-situ hydrocarbon fluids. Secondary production may also be supported and extended by the use of artificial lift methods. The secondary recovery stage is typically accepted to have reached its limit when the injected fluid is produced in considerable amounts from the production wells and the production is no longer economically viable.

After primary and/or secondary production, enhanced oil recovery can be applied.

Enhanced oil recovery methods generally comprise injecting into a production well an enhanced oil recovery formulation which can contain various compounds.

WO2014105588 describes a process for injecting into an underground formation comprising oil or bitumen having a total acid number of at least 0.1 an oil recovery formulation comprising ammonia and low quality steam having a vapor quality of from greater than 0 to less than 0.7.

WO2014105591 describes an enhanced oil recovery method utilizing an alkaline-surfactant-polymer (“ASP”) formulation comprising a surfactant, ammonia liquid, a polymer and water.

These ammonia containing formulations have the advantage over conventional ASP formulations containing hydroxides or carbonates, more specifically sodium carbonate, that less storage space is required and the relative weight is lower which is especially relevant for offshore applications which have limitations on space and weight. Furthermore, in oil-bearing formations containing a significant concentration of calcium ions dispersed in water and/or oil in the formation or dispersed along the surfaces of the formation, use of an alkali such as a carbonate in an ASP flood enhanced oil recovery process contributes to the build-up of scale in production well strings. Water-soluble alkalis used in an ASP flood such as sodium carbonate react with calcium from the formation water, oil, or surfaces to form calcium carbonate. Contact of the alkali carbonate of the ASP flood with calcium in the formation near the production well can induce the formation of calcium carbonate, some of which precipitates and deposits as scale in the production well strings. When the calcium content of a formation is high, such scale deposition may require that the production string either be periodically treated to remove the scale or that the production string be periodically replaced.

It has now surprisingly been found that the recovery of oil from an underground formation with the help of an ammonia containing enhanced oil recovery formulation can be improved.

### SUMMARY OF THE INVENTION

The present invention relates to a process for recovering oil and gas from an underground formation by injecting an ammonia containing enhanced oil recovery formulation into the oil-bearing formation, which process comprises
(i) reacting steam with methane containing gas in the presence of a steam reforming catalyst at a temperature of from 700 to 1100° C. to obtain hydrogen and carbon monoxide,
(ii) combining the reaction mixture obtained in step (i) with further steam to obtain a product containing carbon dioxide and more hydrogen,
(iii) removing carbon dioxide from the product of step (ii) to obtain hydrogen,
(iv) reacting at least part of the hydrogen obtained in step (iii) with nitrogen at a pressure of 15 to 25 MPa and a temperature of from 400 to 500° C.,
(v) separating ammonia from the reaction mixture obtained in step (iv),
(vi) mixing ammonia obtained in step (iv) with water and injecting an enhanced oil recovery formulation containing this mixture into the underground formation via a production well,
(vii) recovering oil and gas from the underground formation via a recovery well,
(viii) separating methane containing gas from the fluid recovered from the recovery well,
(ix) removing sulfur compounds from at least part of the gas which has been separated off to obtain treated methane containing gas, and
(x) using in step (i) the treated methane containing gas obtained in step (ix).

### DETAILED DESCRIPTION OF THE INVENTION

The process of the present invention uses methane obtained from the underground formation or a nearby formation for preparing ammonia for use in the enhanced oil recovery formulation. The preparation can be carried out by the well-known Haber-Bosch process which involves the following steps.

Step i) is referred to as steam reforming and involves reacting methane with steam in the presence of a steam reforming catalyst at a temperature of from 700 to 1100° C. to obtain hydrogen and carbon monoxide. This step generally is carried out at elevated pressure such as a pressure of from 100 to 300 bar, more specifically of from 175 to 225 bar. Suitable methane containing gas can be natural gas. In order to prevent deactivation of the catalyst, the methane containing gas is to be substantially free of sulphur compounds. Sulphur removal can be carried out by catalytic hydrogenation to convert sulfur compounds in the feedstock to gaseous hydrogen sulphide. The gaseous hydrogen sulphide subsequently can be adsorbed and removed by passing it through an adsorption bed such as zinc oxide. Preferably all methane used in step (i) is added as natural gas, more preferably natural gas obtained from the reservoir or a related reservoir. Reservoirs are considered to be related if oil recovery in the one reservoir can influence the oil recovery in the other.

Step (ii) is known as the catalytic shift conversion in which carbon monoxide present in the mixture obtained in step (i) is reacted with water to convert carbon monoxide to carbon dioxide and more hydrogen. This reaction can be carried out at relatively low temperature in the presence of a catalyst containing copper oxide, zinc oxide and aluminum oxide. Alternatively, this step is carried out at relatively high temperature in the presence of a catalyst containing iron oxide, chromium oxide and a minor amount of magnesium oxide.

Carbon dioxide is to be removed from the reaction mixture obtained in step (ii) before further processing. The carbon dioxide can be removed in any way known to be suitable to someone skilled in the art. Known methods comprise absorption in aqueous ethanolamine solutions and adsorption in pressure swing adsorbers. In order to ensure that all carbon monoxide and carbon dioxide are removed, the gas can subsequently be subjected to so-called methanation in which carbon monoxide and/or carbon dioxide are reacted with hydrogen to methane and water in the presence of a suitable methanation catalyst such as a nickel catalyst at a temperature of from 400 to 600° C. and a pressure of up to 3 MPa.

The product of step (iii) is a gas containing a substantial amount of hydrogen and free from oxygen containing compounds such as carbon monoxide and carbon dioxide. It may be desirable to use part of the hydrogen in other processes. Generally, all hydrogen will be used in the process of the present invention.

In step (iv), nitrogen is reacted with the product of step (iii) at a pressure of from 15 to 35 MPa and a temperature of from 400 to 500° C. in the presence of a catalyst, preferably a catalyst containing iron oxide. Due to the relatively low single pass conversion rates, a large recycle stream tends to be applied. Nitrogen generally is obtained from the air. The nitrogen can be added in step (i), (ii) or (iii). Preferably, nitrogen is added in step (i).

Ammonia is separated as product from the reaction mixture of step (iv). Generally, the ammonia gas obtained is compressed and cooled to a temperature of at most −33° C. for storage.

The ammonia is mixed with water before being injected into the formation via the production well. Water for use in the enhanced oil recovery formulation can be derived from various sources. The water may be provided from a water source such as a river, a lake, a fresh water sea, an aquifer, formation water, seawater, brackish water or a brine solution provided by processing a feed water source. Furthermore, it is possible to use water produced in the oil recovery. The Total Dissolved Solids (TDS) content as measured by ASTM D5907-13 is often used as a measure for the amount of salt present in water. A further relevant feature is the hardness of the water. The hardness is the amount of multivalent cations present. The hardness of the water is especially important as these cations tend to lead to scaling in the formation. The multivalent cation content can be determined with the help of ASTM D1126.

The water used in the process of the present invention generally will have a TDS of from 5000 to 200,000 ppm. The water generally will have a TDS of at least 10,000 ppm, more specifically at least 15,000 ppm, most specifically at least 20,000 ppm. The water generally will contain at least 5 parts per million mass (ppm) of multivalent cations, more especially at least 8 ppm.

It was found that it is especially advantageous to mix the ammonia in step (vi) with water having a low TDS. It was found that the use of ammonia in combination with water having a low TDS can lead to higher oil recovery. A further advantage is that the ammonia hardly increases the salinity of the water. Additionally, ammonia is thought to be effective in reversing wettability to water-wet systems and ionization of petroleum acids leading to lower interfacial tensions between oil and water. Preferably, the water has a TDS of at most 60,000 ppm, especially if used with carbonate formations. More preferably, the water had a TDS of at most 30,000 ppm, more specifically at most 20,000 ppm, more specifically at most 10,000 ppm, most specifically at most 5,000 ppm.

The enhanced oil recovery formulation generally will contain at most 20% wt of ammonia on total amount of enhanced oil recovery formulation, more specifically at most 10% wt of ammonia, more specifically at most 5% wt of ammonia, more specifically at most 3% wt of ammonia, more specifically at most 1% wt of ammonia. The amount of ammonia preferably is at least 0.1% wt of ammonia. These amounts are the total of ammonia and related compounds such as ammonium hydroxide and ammonium salts.

The enhanced oil recovery formulation can contain further compounds such as surfactants. The surfactant preferably is an anionic surfactant selected from the group consisting of an alpha olefin sulfonate compound, an internal olefin sulfonate compound, a branched alkyl benzene sulfonate compound, a propylene oxide sulfate compound, an ethylene oxide sulfate compound, a propylene oxide-ethylene oxide sulfate compound, or a blend thereof. The surfactant preferably contains of from 10 to 30 carbon atoms. The surfactant most preferably is a blend of a propylene oxide-ethylene oxide sulfate compound and an internal olefin sulfonate compound.

The amount of ammonia in an enhanced oil recovery formulation comprising surfactant is preferably such that the molar ratio of ammonia to the surfactant is in the range of from 2:1-100:1, preferably in the range of from 5:1-100:1, and more preferably in the range of from 10:1-100:1.

The enhanced oil recovery formulation can furthermore contain polymer.

A preferred polymer is a partly hydrogenated polyacrylamide.

What is claimed is:

1. A process for recovering oil and gas from an underground formation by injecting an ammonia containing enhanced oil recovery formulation into the oil-bearing formation, which process comprises
(i) reacting steam with methane containing gas in the presence of a steam reforming catalyst at a temperature of from 700 to 1100° C. to obtain hydrogen and carbon monoxide,
(ii) combining the reaction mixture obtained in step (i) with further steam to obtain a product containing carbon dioxide and more hydrogen,
(iii) removing carbon dioxide from the product of step (ii) to obtain hydrogen,
(iv) reacting at least part of the hydrogen obtained in step (iii) with nitrogen at a pressure of 15 to 35 MPa and a temperature of from 400 to 500° C.,
(v) separating ammonia from the reaction mixture obtained in step (iv),
(vi) mixing ammonia obtained in step (iv) with water and injecting enhanced oil recovery formulation containing this mixture into the underground formation via a production well,
(vii) recovering oil and gas from the underground formation via a recovery well,
(viii) separating methane containing gas from the fluid recovered from the recovery well,
(ix) removing sulfur compounds from at least part of the gas which has been separated off to obtain treated methane containing gas, and
(x) using in step (i) the treated methane containing gas obtained in step (ix).

2. A process according to claim 1, in which process the enhanced oil recovery formulation further comprises surfactant.

3. A process according to claim 2, in which process the molar ratio of ammonia to surfactant is in the range of from 5:1-100:1.

4. A process according claim 2 or 3 in which the surfactant is an anionic surfactant selected from the group consisting of an alpha olefin sulfonate compound, an internal olefin sulfonate compound, a branched alkyl benzene sulfonate compound, a propylene oxide sulfate compound, an ethylene oxide sulfate compound, a propylene oxide-ethylene oxide sulfate compound, or a blend thereof.

5. A process according to claim 1 or 2 in which process the enhanced oil recovery formulation further comprises polymer.

6. A process according to claim 5 in which process the polymer is a partly hydrogenated polyacrylamide.
